(19) United States
(12) Patent Application Publication
(10) Pub. No.: US 2012/0274975 A1
(43) Pub. Date: Nov. 1, 2012

(54) PRINTING SYSTEM, PRINT DATA GENERATOR, PROCESSOR, PRINTING METHOD AND NON-TRANSITORY RECORDING MEDIUM

(75) Inventor: Atsushi Uemura, Osaka (JP)

(73) Assignee: Sharp Kabushiki Kaisha, Osaka (JP)

(21) Appl. No.: 13/454,663

(22) Filed: Apr. 24, 2012

(30) Foreign Application Priority Data
Apr. 26, 2011 (JP) 2011-098402

(51) Int. Cl. G06K 15/02; G06F 3/12

(52) U.S. Cl. 358/1.14; 358/1.15

(57) ABSTRACT

A printing system, including a plurality of printers, a print data generation section for generating print data printable by one or a plurality of the printers, and a decision section for deciding, based on information concerning printing functions of each of the plurality of printers, whether to generate shared print data printable by a plurality of printing functions or to generate dedicated print data printable by a single printing function, wherein the print data generation section generates the shared print data or the dedicated print data based on a result of the decision made by the decision section.

### CROSS-REFERENCE TO RELATED APPLICATIONS

This Nonprovisional application claims priority under 35 U.S.C. §119(a) on Patent Application No. 2011-98402 filed in Japan on Apr. 26, 2011, the entire contents of which are hereby incorporated by reference.

### FIELD

The present invention relates to a printing system, a print data generator, a processor, a printing method and a non-transitory recording medium for generating print data printable by one or a plurality of printers.

### BACKGROUND

Conventionally, when document data generated by using a data generator capable of generating document data such as documents or pictures, e.g., a personal computer (hereinafter referred to as a “PC”), is printed, print data printable by a printer is generated based on the generated document data and the generated print data is outputted to the printer by means of a printer driver installed on the PC in advance.

In recent years, a plurality of different models of printers have been connected to a PC via a network and the printer to be used has been selected in consideration of document contents, amount, etc. For example, when a document includes a picture with a plurality of colors, a printer capable of performing color printing is selected, and when a large number of documents are created, a printer capable of performing printing at a high speed is selected. Further, when printing cannot be performed due to occurrence of an error in the selected printer, e.g., when a paper jam has occurred in the selected printer, another printer is selected.

For example, Japanese Patent Application Laid-Open No. 2005-165713 discloses a printing system including a printer, a server computer, and a plurality of printer hosts. In this printing system, driver settings of the printer hosts are remotely changed from the server computer, thereby allowing updates to be performed on printer driver settings in the network printing system.

However, in such a printing system including a printer, a server and a PC, the printer for carrying out printing is not determined before printing is actually performed, and therefore, the PC for creating print data needs to create print data printable by all of a plurality of models of printers used in the printing system.

For example, in order to perform printing by both of a color printer and a black-and-white printer, print data has to be provided as color print data. However, even when the actually selected printer is a black-and-white printer, the generated color print data has to be transmitted to and accumulated in the server in advance. As compared with black-and-white print data most suitable for a black-and-white printer, color print data has a larger file size, thus causing a problem that it takes time to communicate with the server for the print data and to print the print data.

Furthermore, in the case of a color printer, a color profile for obtaining an output most suitable for each model might be required; however, since the model of a printer to be used is unknown at the time of creation of print data, there is no other choice but to use a profile usable for a plurality of models, and thus it might be impossible to obtain print data most suitable for each model.

### SUMMARY

The present invention has been made in view of the above-described circumstances, and its object is to provide a printing system, a print data generator, a processor, a printing method and a non-transitory recording medium which allow generation of print data most suitable for a printer that should carry out a printing process, thus enabling increases in transmission/reception speed and printing speed.

One aspect of the present invention provides a printing system including: a plurality of printers; a print data generation section for generating print data printable by one or a plurality of the printers; and a decision section for deciding, based on information concerning printing functions of each of the plurality of printers, whether to generate shared print data printable by a plurality of printing functions or to generate dedicated print data printable by a single printing function, wherein the print data generation section generates the shared print data or the dedicated print data based on a result of the decision made by the decision section.

According to the foregoing aspect of the present invention, the decision section decides, based on information concerning printing functions of each of the plurality of printers, whether to generate shared print data printable by a plurality of printing functions or to generate dedicated print data printable by a single printing function, and the print data generation section generates the shared print data or the dedicated print data based on a result of the decision made by the decision section.

Another aspect of the present invention provides the printing system wherein when all pieces of information concerning the same type of printing functions of the plurality of printers are identical, the decision section decides to generate the dedicated print data, and when the pieces of information concerning the same type of printing functions of the plurality of printers are not identical, the decision section decides to generate the shared print data.

According to the foregoing aspect of the present invention, when all pieces of information concerning the same type of printing functions of the plurality of printers are identical, the decision section decides to generate the dedicated print data, and when the pieces of information concerning the same type of printing functions of the plurality of printers are not identical, the decision section decides to generate the shared print data.

Still another aspect of the present invention provides the printing system further including: a setting section for registering a plurality of users and the plurality of printers, and for making a setting to allow each of the printers to be usable or unusable for each user; and a determination section for acquiring user information, and for determining, based on the setting made by the setting section, the printers, of the plurality of printers, usable by the user associated with the acquired information, wherein the decision section decides whether to generate the shared print data or to generate the dedicated print data based on the information concerning the printing functions of the printer determined by the determination section.

According to the foregoing aspect of the present invention, the setting section registers a plurality of users and the plurality of printers, and makes a setting to allow each of the printers to be usable or unusable for each user. The determination section acquires user information, and determines, based on the setting made by the setting section, the printers, of the plurality of printers, usable by the user associated with the acquired information. And the decision section decides whether to generate the shared print data or to generate the dedicated print data based on the information concerning the printing functions of the printer determined by the determination section.

Yet another aspect of the present invention provides a print data generator for generating print data, the print data generator including: an acquisition section for acquiring information concerning a plurality of printing functions; and a decision section for deciding, based on the information acquired by the acquisition section, whether to generate shared print data printable by a plurality of printing functions or to generate dedicated print data printable by a single printing function, wherein the print data generator generates the shared print data or the dedicated print data based on a result of the decision made by the decision section.

According to the foregoing aspect of the present invention, the acquisition section acquires information concerning a plurality of printing functions. The decision section decides, based on the information acquired by the acquisition section, whether to generate shared print data printable by a plurality of printing functions or to generate dedicated print data printable by a single printing function. And the print data generator generates the shared print data or the dedicated print data based on a result of the decision made by the decision section.

Even yet another aspect of the present invention provides the print data generator wherein when all pieces of information concerning the same type of printing functions, of the plurality of printing functions, are identical, the decision section decides to generate the dedicated print data, and when the pieces of information concerning the same type of printing functions, of the plurality of printing functions, are not identical, the decision section decides to generate the shared print data.

According to the foregoing aspect of the present invention, when all pieces of information concerning the same type of printing functions, of the plurality of printing functions, are identical, the decision section decides to generate the dedicated print data, and when the pieces of information concerning the same type of printing functions, of the plurality of printing functions, are not identical, the decision section decides to generate the shared print data.

Still yet another aspect of the present invention provides the print data generator further including: a setting section for registering a plurality of users and a plurality of printers, and for making a setting to allow each of the printers to be usable or unusable for each user; and a determination section for acquiring user information, and for determining, based on the setting made by the setting section, the printers, of the plurality of printers, usable by the user associated with the acquired information, wherein the acquisition section acquires information concerning printing functions of the printers, of the plurality of printers, determined by is the determination section.

According to the foregoing aspect of the present invention, the setting section registers a plurality of users and a plurality of printers, and makes a setting to allow each of the printers to be usable or unusable for each user. The determination section acquires user information, and determines, based on the setting made by the setting section, the printers, of the plurality of printers, usable by the user associated with the acquired information. And the acquisition section acquires information concerning printing functions of the printers, of the plurality of printers, determined by the determination section.

Even still yet another aspect of the present invention provides a processor for carrying out a process for deciding print data printable by one or a plurality of printers to be connected, the processor including a decision section for deciding, based on information concerning printing functions of the plurality of printers, whether to generate shared print data printable by a plurality of printing functions or to generate dedicated print data printable by a single printing function.

According to the foregoing aspect of the present invention, the decision section decides, based on information concerning printing functions of each of the plurality of printers, whether to generate shared print data printable by a plurality of printing functions or to generate dedicated print data printable by a single printing function.

Another aspect of the present invention provides the processor wherein when all pieces of information concerning the same type of printing functions of the plurality of printers are identical, the decision section decides to generate the dedicated print data, and when the pieces of information concerning the same type of printing functions of the plurality of printers are not identical, the decision section decides to generate the shared print data.

According to the foregoing aspect of the present invention, when all pieces of information concerning the same type of printing functions of the plurality of printers are identical, the decision section decides to generate the dedicated print data, and when the pieces of information concerning the same type of printing functions of the plurality of printers are not identical, the decision section decides to generate the shared print data.

Still another aspect of the present invention provides the processor further including: a setting section for registering a plurality of users and the plurality of printers, and for making a setting to allow each of the printers to be usable or unusable for each user; and a determination section for acquiring user information, and for determining, based on the setting made by the setting section, the printers, of the plurality of printers, usable by the user associated with the acquired information, wherein the decision section decides whether to generate the shared print data or to generate the dedicated print data based on the information concerning the printing functions of the printer determined by the determination section.

According to the foregoing aspect of the present invention, the setting section registers a plurality of users and the plurality of printers, and makes a setting to allow each of the printers to be usable or unusable for each user. The determination section acquires user information, and determines, based on the setting made by the setting section, the printer, of the plurality of printers, usable by the user associated with the acquired information. And the decision section decides whether to generate the shared print data or to generate the dedicated print data based on the information concerning the printing functions of the printer determined by the determination section.

Yet another aspect of the present invention provides a printing method for generating print data printable by one or a plurality of printers, and for performing printing based on the generated print data, the method including the steps of; deciding, based on information concerning printing functions of each of the plurality of printers, whether to generate shared print data printable by a plurality of printing functions or to generate dedicated print data printable by a single printing function; and generating the shared print data or the dedicated print data based on a result of the decision.

According to the foregoing aspect of the present invention, the method includes the step of deciding, based on information concerning printing functions of each of the plurality of printers, whether to generate shared print data printable by a plurality of printing functions or to generate dedicated print data printable by a single printing function. The method further includes the step of generating the shared print data or the dedicated print data based on a result of the decision.

Even yet another aspect of the present invention provides the printing method including the steps of: deciding to generate the dedicated print data when all pieces of information concerning the same type of printing functions of the plurality of printers are identical; and deciding to generate the shared print data when the pieces of information concerning the same type of printing functions of the plurality of printers are not identical.

According to the foregoing aspect of the present invention, the printing method includes the steps of: deciding to generate the dedicated print data when all pieces of information concerning the same type of printing functions of the plurality of printers are identical; and deciding to generate the shared print data when the pieces of information concerning the same type of printing functions of the plurality of printers are not identical.

Still yet another aspect of the present invention provides the printing method including the steps of: registering a plurality of users and the plurality of printers and making a setting to allow each of the printers to be usable or unusable for each user; acquiring user information and determining the printers, of the plurality of printers, set to be usable by the user associated with the acquired information; and deciding whether to generate the shared print data or to generate the dedicated print data based on the information concerning the printing functions of the determined printer.

According to the foregoing aspect of the present invention, the method includes the step of registering a plurality of users and the plurality of printers and making a setting to allow each of the printers to be usable or unusable for each user. The method further includes the step of acquiring user information and determining the printers, of the plurality of printers, set to be usable by the user associated with the acquired information. And the method further includes the step of deciding whether to generate the shared print data or to generate the dedicated print data based on the information concerning the printing functions of the determined printer.

Even still yet another aspect of the present invention provides a computer program for a computer for generating print data printable by one or a plurality of printers to be connected, the computer program including the steps of: allowing the computer to decide, based on information concerning printing functions of the plurality of printers, whether to generate shared print data printable by a plurality of printing functions or to generate dedicated print data printable by a single printing function; and allowing the computer to generate the shared print data or the dedicated print data based on a result of the decision.

According to the foregoing aspect of the present invention, the computer program allows the computer to function as: a decision section for deciding, based on information concerning printing functions of the plurality of printers, whether to generate shared print data printable by a plurality of printing functions or to generate dedicated print data printable by a single printing function; and a print data generation section for generating the shared print data or the dedicated print data based on a result of the decision made by the decision section.

Another aspect of the present invention provides a non-transitory recording medium wherein the foregoing computer program according to the present invention is recorded in the non-transitory recording medium.

According to the foregoing aspect of the present invention, the foregoing computer program is recorded in the non-transitory recording medium. The computer program is read from the non-transitory recording medium by a computer, and the foregoing print data generator is implemented by the computer.

According to the present invention, whether to generate shared print data printable by a plurality of printing functions or to generate dedicated print data printable by a single printing function is decided based on information concerning printing functions of each of a plurality of printers, and the shared print data or the dedicated print data is generated based on a result of the decision, thus making it possible to generate print data most suitable for the printer that should carry out a printing process, and to increase a print data transmission/reception speed and a printing speed.

The above and further objects and features of the invention will more fully be apparent from the following detailed description with accompanying drawings.

### BRIEF DESCRIPTION OF DRAWINGS

FIG. 1 is a schematic diagram illustrating an overall configuration of a printing system according to Embodiment 1 of the present invention.

FIG. 2 is a block diagram illustrating configurations of main devices of the printing system according to Embodiment 1.

FIG. 3 is a flow chart illustrating a procedure of processing for printer settings performed by a server.

FIG. 4 is a diagram illustrating an exemplary printer registration information table.

FIG. 5 is a diagram illustrating an exemplary printer setting information table.

FIG. 6 is a flow chart illustrating a procedure of processing for generating print data in a PC.

FIG. 7 is a flow chart illustrating a procedure of processing of a subroutine for deciding print data in the PC.

FIGS. 8A to 8C are diagrams each illustrating an exemplary UI screen for receiving a print setting operation.

FIG. 9A is a diagram illustrating exemplary printer information acquired by the PC.

FIG. 9B is a diagram illustrating an exemplary printer model information table.

FIG. 9C is a diagram illustrating an exemplary initial print data decision table.

FIG. 9D is a diagram illustrating an exemplary updated print data decision table.

FIG. 10 is a flow chart illustrating a procedure of processing for transmitting printer information with the server.

FIG. 11 is a flow chart illustrating a procedure of processing for accumulating print data in the server.

FIG. 12 is a flow chart illustrating a procedure of processing for acquiring print data and performing printing with a printer.

FIG. 13 is a flow chart illustrating a procedure of processing for transmitting print data with the server.

FIG. 14 is a block diagram illustrating configurations of main devices of a printing system according to Embodiment 2 of the present invention.

FIG. 15 is a flow chart illustrating a procedure of processing performed by a PC according to Embodiment 2.

FIG. 16 is a flow chart illustrating a procedure of processing performed by a server according to Embodiment 2.

FIG. 17 is a block diagram illustrating an exemplary configuration of a PC according to Embodiment 3 of the present invention.

### BEST MODE FOR CARRYING OUT THE INVENTION

Hereinafter, the present invention will be described in detail with reference to the drawings illustrating printing systems according to embodiments of the present invention.

### Embodiment 1

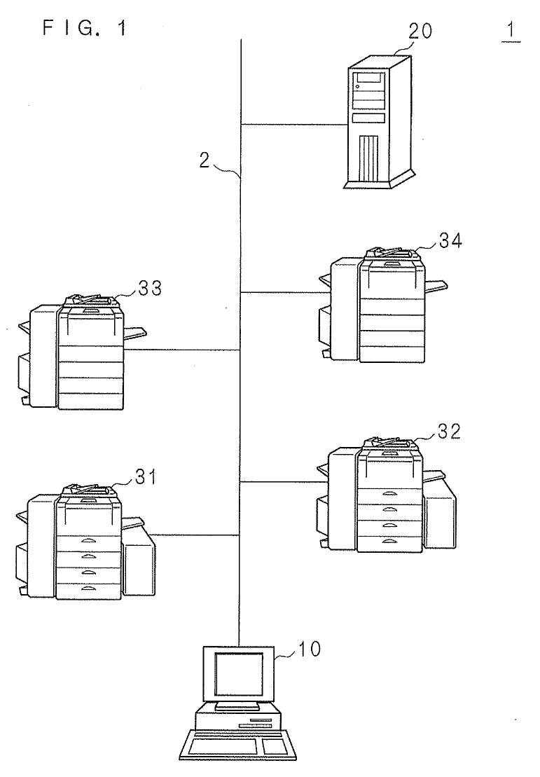

FIG. 1 is a schematic diagram illustrating an overall configuration of a printing system according to Embodiment 1 of the present invention. The printing system 1 includes: a PC 10 serving as a print data generator; a server 20; and first to fourth printers 31 to 34, each serving as a printer. The PC 10, the server 20, and the first to fourth printers 31 to 34 are connected to each other via a wired or wireless LAN network 2, for example.

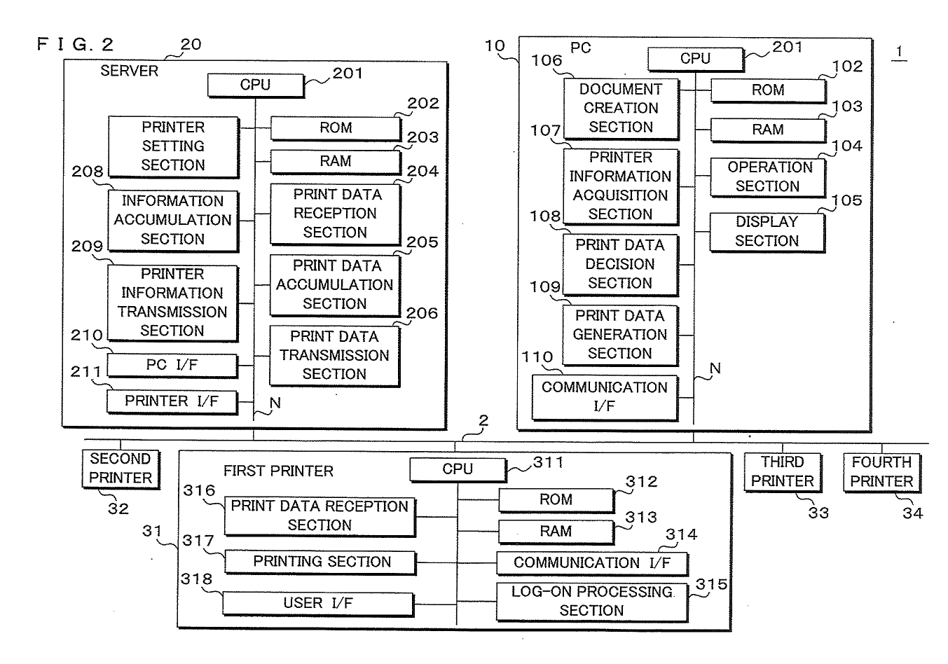

FIG. 2 is a block diagram illustrating configurations of main devices of the printing system according to Embodiment 1. As illustrated in FIG. 2, the PC 10 includes a CPU 101, a ROM 102, and a RAM 103. In the ROM 102, a control program executed by the CPU 101 is stored. The RAM 103 is capable of temporarily storing data generated in the course of execution of the control program. The CPU 101 loads the control program, stored in advance in the ROM 102, into the RAM 103 and executes the control program, thereby controlling operations of the entire PC 10 via a bus N.

In addition, the PC 10 further includes: an operation section 104 including a keyboard, a mouse, a touch panel, etc.; a display section 105 for displaying an image; a document creation section 106 for creating a document; a printer information acquisition section 107 for acquiring printer information from the server 20; a print data decision section 108 for deciding print data; a print data generation section 109 for generating print data; and a communication I/F 110 for communicating with the server 20.

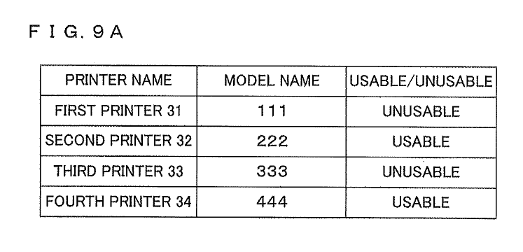

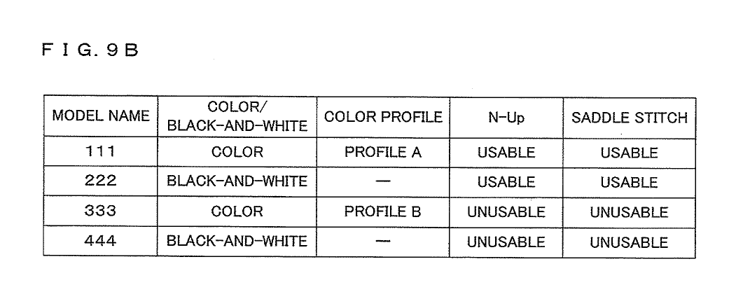

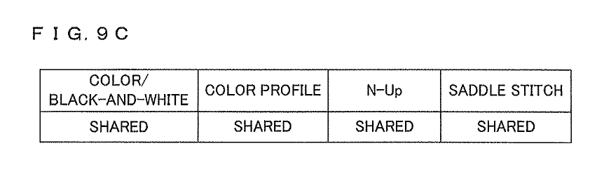

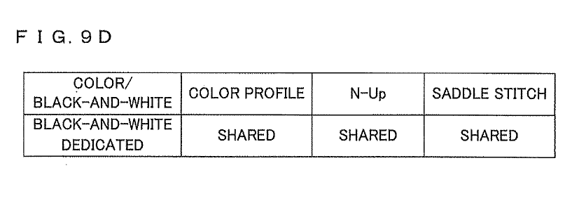

The document creation section 106 is an application such as MS-Word, for example, and creates a document in accordance with an instruction provided from the operation section 104. The printer information acquisition section 107 is a printer driver, for example, and transmits, to the server 20, a request for acquisition of printer information concerning the first to fourth printers 31 to 34 usable/unusable by a user; at the same time, the printer information acquisition section 107 also transmits, to the server 20, log-on information such as the user's log-on name and password so as to acquire, from the server 20, printer information (see FIG. 9A) associated with the user.

The print data decision section 108 is a printer driver, for example, and retains model information (see FIG. 9B) of the first to fourth printers 31 to 34 in advance. Based on the retained model information of each printer and the printer information acquired by the printer information acquisition section 107, the print data decision section 108 obtains information concerning printing functions of the printers usable by the user so as to decide, based on the obtained information, whether to generate shared print data printable by a plurality of printing functions or to generate dedicated print data printable by a single printing function.

The print data generation section 109 is a printer driver, for example, and generates print data in accordance with a result of the decision made by the print data decision section 108. The CPU 101 transmits the print data, generated by the print data generation section 109, to the server 20 via the communication I/F 110.

The server 20 includes a CPU 201, a ROM 202 and a RAM 203. In the ROM 202, a control program executed by the CPU 201 is stored. The RAM 203 is capable of temporarily storing data generated in the course of execution of the control program. The CPU 201 loads the control program, stored in advance in the ROM 202, into the RAM 203 and executes the control program, thereby controlling operations of the entire server 20 via a bus N.

The server 20 further includes: a print data reception section 204 for receiving print data transmitted from the PC 10; a print data accumulation section 205 for accumulating print data; a print data transmission section 206 for transmitting print data to the printers; a printer setting section 207 for registering users and each printer and for making a setting to allow each of the printers to be usable or unusable for each user; an information accumulation section 208 for accumulating various registration information and printer setting information provided by the printer setting section 207; a printer information transmission section 209 for transmitting printer information to the PC 10; a PC I/F 210 for communicating with the PC 10; and a printer I/F 211 for communicating with the printers.

The print data reception section 204 receives print data from the PC 10 via the PC I/F 210. The print data accumulation section 205 accumulates the print data received by the print data reception section 204. In response to a print data acquisition request from any one of the first to fourth printers 31 to 34, the print data transmission section 206 transmits, to this printer, the print data accumulated by the print data accumulation section 205.

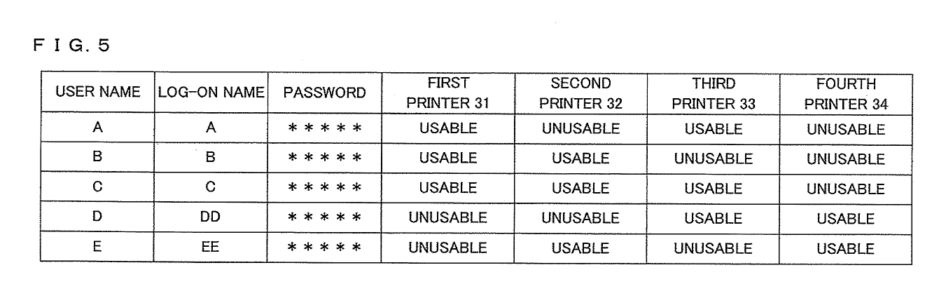

The printer setting section 207 performs registration of; users utilizing the printing system 1 according to the present embodiment; and the first to fourth printers 31 to 34, makes a setting to allow each of the printers to be usable or unusable for each user, and creates a printer setting information table (see FIG. 5). Information to be registered in this embodiment may include user name and password of each user, and name and IP address of each printer, for example, but information to be registered is not limited to the above-mentioned information. Alternatively, information to be registered may be changed when necessary.

The information accumulation section 208 is a HDD, for example, and accumulates the various registration information and printer setting information registered by the printer setting section 207. In response to the printer information acquisition request from the printer information acquisition section 107 of the PC 10, the printer information transmission section 209 determines the printers usable by the user based on: the user's log-on information received along with the acquisition request; and the printer setting information accumulated by the information accumulation section 208, generates printer information associated with the user, and transmits the printer information to the PC 10 via the PC I/F 210.

Further, each of the first to fourth printers 31 to 34 includes a CPU 311, a ROM 312 and a RAM 313. In the ROM 312, a control program executed by the CPU 311 is stored. The RAM 313 is capable of temporarily storing data generated in the course of execution of the control program. The CPU 311 loads the control program, stored in advance in the ROM 312, into the RAM 313 and executes the control program, thereby controlling operations of the entire printer via a bus N.

Each of the first to fourth printers 31 to 34 further includes: a communication I/F 314 for communicating with the server 20; a log-on processing section 315 for performing a log-on process for the user; a print data reception section 316 for receiving print data from the server 20; a printing section 317 for performing printing based on the received print data; and a user I/F 318 operated by the user.

The log-on processing section 315 performs processing on log-on information inputted by the user via the user I/F 318. The print data reception section 316 transmits a print data acquisition request to the server 20 via the communication I/F 314; at the same time, the print data reception section 316 also transmits the log-on information, provided by the log-on processing section 315, to the server 20 via the communication I/F 314 so as to receive, from the server 20, print data associated with the user. The printing section 317 performs printing based on the print data received by the print data reception section 316.

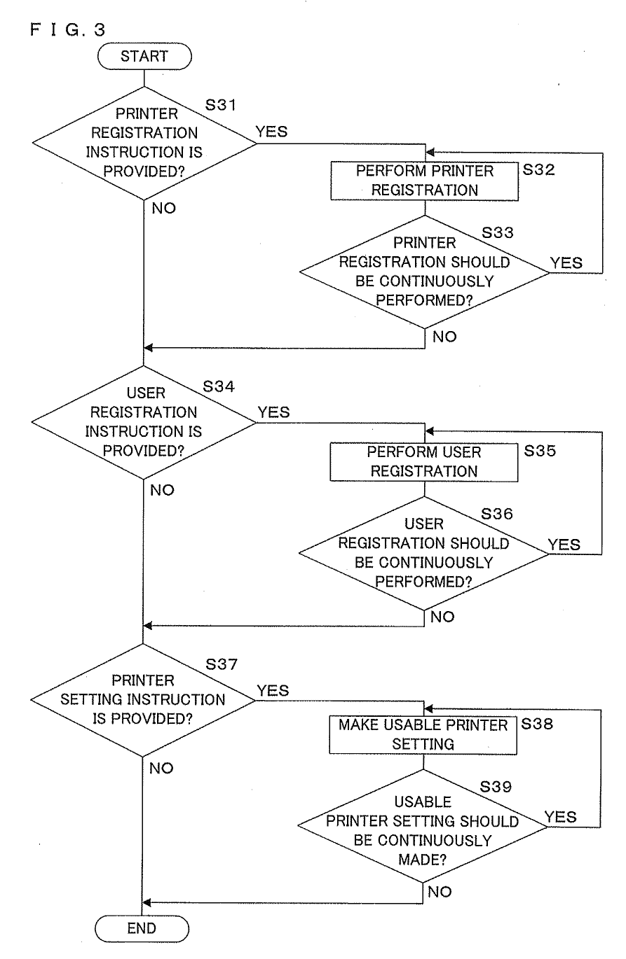

FIG. 3 is a flow chart illustrating a procedure of processing for printer settings performed by the server 20. As illustrated in FIG. 3, the CPU 201 in the server 20 determines whether or not a printer registration instruction is provided from the user (Step S31). Upon determination that no printer registration instruction is provided (Step S31: NO), the CPU 201 moves the processing to Step S34 described later.

Upon determination that a printer registration instruction is provided (Step S31: YES), the CPU 201 provides the printer registration instruction to the printer setting section 207. In accordance with the instruction from the CPU 201, the printer setting section 207 registers information such as name, model and IP address of the printer, for example, thereby performing registration of the printer to be used in the printing system (Step S32).

The CPU 201 determines whether or not printer registration should be continuously performed (Step S33). Upon determination that printer registration should be continuously performed (Step S33: YES), the CPU 201 instructs the printer setting section 207 to perform printer registration, and returns the processing to Step S32.

Upon determination that printer registration should not be continuously performed (Step S33: NO), the CPU 201 determines whether or not a user registration instruction is provided from the user (Step S34).

Upon determination that no user registration instruction is provided from the user (Step S34: NO), the CPU 201 moves the processing to Step S37 described later.

Upon determination that a user registration instruction is provided (Step S34: YES), the CPU 201 instructs the printer setting section 207 to perform user registration. In accordance with the instruction from the CPU 201, the printer setting section 207 registers information such as name, log-on name and password of the user, for example, thereby performing registration of the user who utilizes the printing system (Step S35).

The CPU 201 determines whether or not user registration should be continuously performed (Step S36). Upon determination that user registration should be continuously performed (Step S36: YES), the CPU 201 instructs the printer setting section 207 to perform user registration, and returns the processing to Step S35.

Upon determination that user registration should not be continuously performed (Step S36: NO), the CPU 201 determines whether or not a printer setting instruction is provided from the user (Step S37).

Upon determination that no printer setting instruction is provided from the user (Step S37: NO), the CPU 201 ends the processing.

Upon determination that a printer setting instruction is provided from the user (Step S37: YES), the CPU 201 instructs the printer setting section 207 to make a printer setting. In accordance with the instruction from the CPU 201, the printer setting section 207 makes a setting to allow each of the registered printers to be usable or unusable for each registered user, thus making the printer setting (Step S38).

The CPU 201 determines whether or not a setting of the printer, which is capable of performing printing for the user, should be continuously made (Step S39). Upon determination that a setting of the printer, which is capable of performing printing for the user, should be continuously made (Step S39: YES), the CPU 201 instructs the printer setting section 207 to make a printer setting, and returns the processing to Step S38.

Upon determination that a setting of the printer, which is capable of performing printing for the user, should not be continuously made (Step S39: NO), the CPU 201 ends the processing.

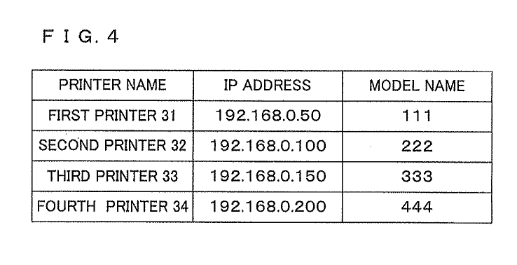

The printer registration information and user registration information registered by the printer setting section 207 as described above, and the printer setting information set by the printer setting section 207 as described above are accumulated in the information accumulation section 208. The printer registration information and printer setting information, accumulated in the information accumulation section 208, may be provided as the printer registration information table illustrated in FIG. 4 and the printer setting information table illustrated in FIG. 5, respectively.

FIG. 4 is a diagram illustrating an example of the printer registration information table. As illustrated in FIG. 4, printer names, IP addresses and model names of the respective printers used in the printing system are written in the printer registration information table.

FIG. 5 is a diagram illustrating an example of the printer setting information table. As illustrated in FIG. 5, user names, log-on names and passwords of the respective users who utilize the printing system 1, and information indicating that the first to fourth printers 31 to 34 are usable/unusable are written in the printer setting information table.

Specifically, the printers usable by the user whose user name is “A” are the first printer 31 and the third printer 33, the printers usable by the user whose user name is “B” are the first printer 31 and the second printer 32, the printers usable by the user whose user name is “C” are the first printer 31, the second printer 32 and the third printer 33, the printers usable by the user whose user name is “D” are the third printer 33 and the fourth printer 34, and the printers usable by the user whose user name is “E” are the second printer 32 and the fourth printer 34.

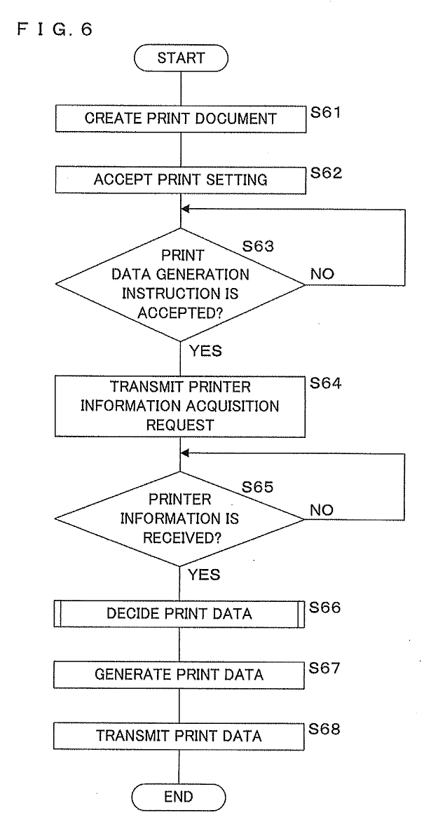

Next, referring to FIGS. 6 to 13, processing performed in the printing system 1 according to the present embodiment will be described.

FIG. 6 is a flow chart illustrating a procedure of processing for generating print data in the PC 10. As illustrated in FIG. 6, the document creation section 106 in the PC 10 creates, in accordance with an instruction from the CPU 101, a document to be printed (Step S61).

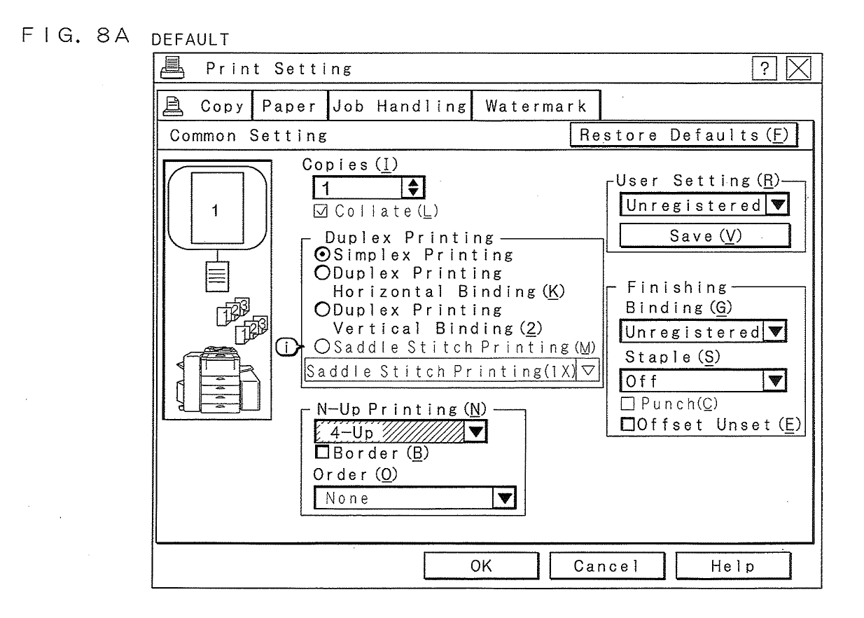

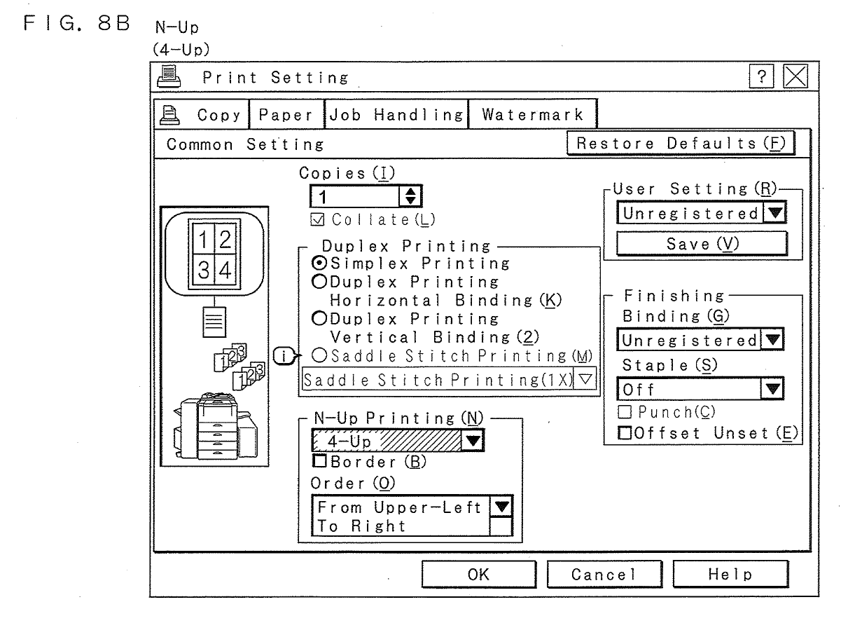

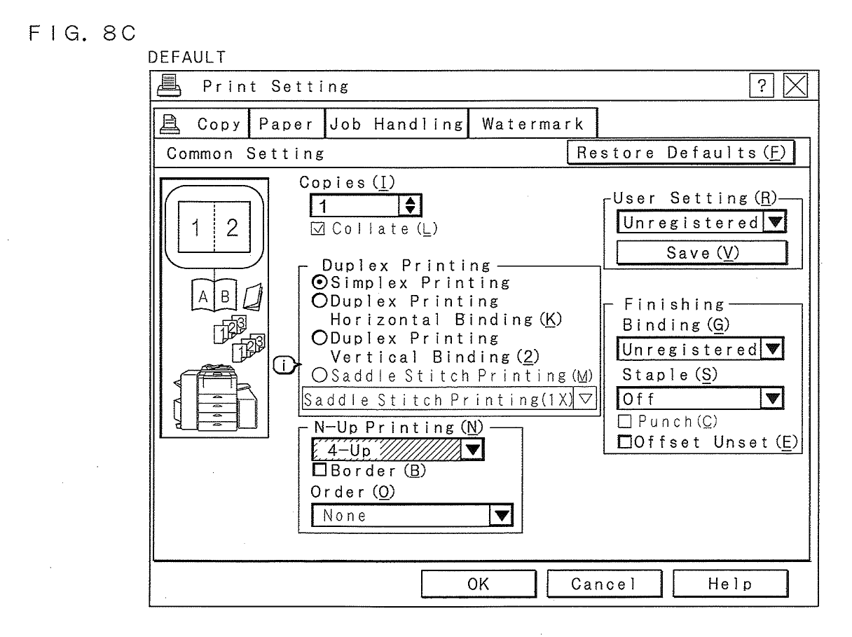

The CPU 101 accepts a print setting operation performed by the user (Step S62). FIGS. 8A to 8C are diagrams each illustrating an exemplary UI screen for accepting a print setting operation. FIG. 8A illustrates a default UI screen, FIG. 8B illustrates a UI screen displayed when an N-Up printing item is set to 4-Up by the user, and FIG. 8C illustrates a UI screen displayed when saddle stitch printing is selected by the user.

The CPU 101 determines whether or not a print data generation instruction is accepted from the user (Step S63). Upon determination that no print data generation instruction is accepted from the user (Step S63: NO), the determination in Step S63 is repeatedly made until a print data generation instruction is accepted.

Upon determination that a print data generation instruction is accepted from the user (Step S63: YES), the CPU 101 instructs the printer information acquisition section 107 to acquire printer information. In accordance with the instruction from the CPU 101, the printer information acquisition section 107 transmits a printer information acquisition request to the server 20 via the communication I/F 110; at the same time, the printer information acquisition section 107 also transmits log-on information such as the user's log-on name and password to the server 20 via the communication I/F 110 (Step S64).

The CPU 101 determines whether or not printer information is received from the server 20 (Step S65). Upon determination that no printer information is received from the server 20 (Step S65: NO), the determination in Step S65 is repeatedly made until printer information is received.

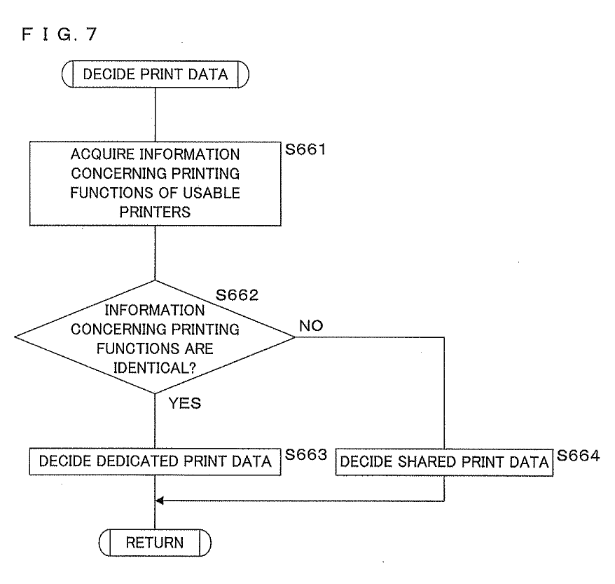

Upon determination that printer information is received from the server 20 (Step S65: YES), the CPU 101 instructs the print data decision section 108 to decide print data. In accordance with the instruction from the CPU 101, the print data decision section 108 invokes a subroutine (see FIG. 7) for deciding print data, and decides what kind of print data should be generated (Step S66).

The CPU 101 instructs the print data generation section 109 to generate print data. In accordance with the instruction from the CPU 101, the print data generation section 109 generates print data based on a result of the decision made in Step S66 (Step S67).

The CPU 101 transmits the generated print data and the user information such as the user's log-on name and password to the server 20 via the communication I/F 110 (Step S68), and then ends the processing.

FIG. 7 is a flow chart illustrating a procedure of processing of the subroutine for deciding print data in the PC 10. As illustrated in FIG. 7, based the printer information (see FIG. 9A) acquired by the printer information acquisition section 107 and the retained printer model information table (see FIG. 9B), the print data decision section 108 acquires information concerning the printing functions of the usable printers (Step S661). FIGS. 9A and 9B are diagrams illustrating exemplary printer information acquired from the server 20 and an example of the retained printer model information table, respectively.

FIG. 9A is a diagram illustrating exemplary printer information acquired by the PC 10. Referring to FIG. 9A, the printer information is associated with the user whose user name is “E” in FIG. 5, and the printers usable by this user are the second printer 32 whose model name is “222” and the fourth printer 34 whose model name is “444”.

FIG. 9B is a diagram illustrating an exemplary printer model information table. Referring to FIG. 9B, the model names of the first to fourth printers 31 to 34, and information concerning a plurality of types of printing functions such as “color/black-and-white”, “color profile”, “N-Up” and “saddle stitch”, for example, are written in the printer model information table. From the table illustrated in FIG. 9B, information concerning the printing functions of each of the second printer 32 and the fourth printer 34 usable by the user “E” is obtained.

Thus, information concerning the printing functions of the printers usable by the user can be acquired based on FIGS. 9A and 9B.

As illustrated in FIG. 7, based on the acquired information concerning the printing functions, the print data decision section 108 determines whether or not all pieces of information concerning a same type of printing functions of the respective printers usable by the user are identical (Step S662). For example, the print data decision section 108 determines whether or not the color/black-and-white functions of the second printer 32 and the fourth printer 34 are identical.

Upon determination that all pieces of information concerning a same type of printing functions of the respective printers are identical (Step S662: YES), the print data decision section 108 decides to generate dedicated print data printable by the identical function (Step S663), and returns the processing to the main routine.

Upon determination that the pieces of information concerning a same type of printing functions of the respective printers are not identical (Step S662: NO), the print data decision section 108 decides to generate shared print data printable by a plurality of functions (Step S664), and returns the processing to the main routine.

In this embodiment, the print data decision section 108 decides print data for each type of printing functions to be considered. For example, when only a “color/black-and-white” function should be considered as a printing function, black-and-white print data or color print data is decided. On the other hand, when a plurality of printing functions should be considered, the process of Step S662 and the process of Step S663 or S664 are repeatedly carried out in accordance with the number of printing functions to be considered. For example, since the printing functions illustrated in FIG. 9B include the four types of printing functions, i.e., a “color/black-and-white” function, a “color profile” function, an “N-Up” function and a “saddle stitch” function, the print data decision section 108 determines whether or not pieces of information concerning each of the four types of printing functions are identical, thus deciding to generate dedicated print data or shared print data.

Specifically, when the user is the user “E” in FIG. 5 and printer information such as that illustrated in FIG. 9A is acquired from the server 20 by the printer information acquisition section 107, the print data decision section 108 determines, as usable printers, the second printer 32 whose model name is “222” and the fourth printer 34 whose model name is “444” based on the printer information, and acquires information concerning the printing functions of each of the second printer 32 and the fourth printer 34 based on the retained printer model information table such as that illustrated in FIG. 9B. As illustrated in FIG. 9B, the second printer 32 is capable of performing black-and-white printing and capable of performing N-Up and saddle stitch printing; on the other hand, the fourth printer 34 is capable of performing black-and-white printing but incapable of performing N-Up and saddle stitch printing.

As for the color/black-and-white function, the second printer 32 and the fourth printer 34 each have the black-and-white function as mentioned above; thus, the print data decision section 108 determines that information concerning the printing function of the second printer 32 and information concerning the printing function of the fourth printer 34 are identical, and decides to generate black-and-white print data, i.e., dedicated print data meant for the black-and-white function. Further, as for the N-Up function, the second printer 32 is capable of performing printing by using the N-Up function but the fourth printer 34 is incapable of performing printing by using the N-Up function; thus, when the print setting is set to N-Up by the user “E” in Step S62, the print data decision section 108 determines that information concerning the printing function of the second printer 32 and information concerning the printing function of the fourth printer 34 are not identical, and decides to generate print data on which a layout process for N-Up has been performed, i.e., shared print data that is printable regardless of whether or not the printer has the N-Up function. Moreover, as for the saddle stitch function, the second printer 32 is capable of performing printing by using the saddle stitch function but the fourth printer 34 is incapable of performing printing by using the saddle stitch function; thus, when the print setting is set to saddle stitch by the user “E” in Step S62, the print data decision section 108 determines that information concerning the printing function of the second printer 32 and information concerning the printing function of the fourth printer 34 are not identical, and decides to generate print data on which a layout process for saddle stitch has been performed, i.e., shared print data that is printable regardless of whether or not the printer has the saddle stitch function.

Furthermore, print data decision tables such as those illustrated in FIGS. 9C and 9D, for example, may be created with results of decisions made as described above. When a next print job is executed, a new decision result may be written in a previous print data decision table so that the print data decision table is updated. FIG. 9C is a diagram illustrating an exemplary initial print data decision table, and FIG. 9D is a diagram illustrating an exemplary updated print data decision table.

On the other hand, when the user is the user “D” in FIG. 5, usable printers are the third printer 33 whose model name is “333” and the fourth printer 34 whose model name is “444”. Based on the model information illustrated in FIG. 9B, information concerning the printing functions of each of the third printer 33 and the fourth printer 34 is acquired.

Specifically, the third printer 33 is capable of performing color printing but incapable of performing N-Up and saddle stitch printing, and a color profile is a profile B in the third printer 33; on the other hand, the fourth printer 34 is capable of performing black-and-white printing but incapable of performing N-Up and saddle stitch printing, and there is no color profile in the fourth printer 34. Thus, as for the color/black-and-white function, the third printer 33 has the color function and the fourth printer 34 has the black-and-white function; therefore, the print data decision section 108 determines that information concerning the printing function of the third printer 33 and information concerning the printing function of the fourth printer 34 are not identical, and decides to generate color print data, i.e., shared print data printable by both of the color function and black-and-white function. As for the color profile, the color profile is the profile B in the third printer 33, and there is no color profile in the fourth printer 34; therefore, the print data decision section 108 determines that information concerning the printing function of the third printer 33 and information concerning the printing function of the fourth printer 34 are not identical, and decides to generate print data for which the profile B is used, i.e., shared print data. Moreover, as for the N-Up function and saddle stitch function, both of the third printer 33 and the fourth printer 34 are incapable of performing printing by using the N-Up function and saddle stitch function; thus, when the print setting is set to N-Up or saddle stitch by the user “D” in Step S62, the print data decision section 108 determines that information concerning the printing function of the third printer 33 and information concerning the printing function of the fourth printer 34 are identical, and decides to generate print data on which a layout process for N-Up or saddle stitch has been performed, i.e., dedicated print data meant for the printer that does not have the N-Up function or the saddle stitch function.

Furthermore, when the user is the user “B” in FIG. 5, usable printers are the first printer 31 whose model name is “111” and the second printer 32 whose model name is “222”. Based on the model information illustrated in FIG. 9B, information concerning the printing functions of each of the first printer 31 and the second printer 32 is acquired.

As for the N-Up function and the saddle stitch function, both of the first printer 31 and the second printer 32 are capable of performing printing by using the N-Up function and the saddle stitch function; thus, when the print setting is set to N-Up or saddle stitch by the user “B” in Step S62, the print data decision section 108 determines that information concerning the printing function of the first printer 31 and information concerning the printing function of the second printer 32 are identical, and decides to generate print data on which a layout process for N-Up or saddle stitch has not been performed, i.e., dedicated print data meant for the printer having the N-Up function or the saddle stitch function. Specifically, when N-Up printing is set by the user, the print data decision section 108 decides print data on which no N-Up layout process has been performed and to which a command for instructing the printer to perform an N-Up layout process inside the printer is added. Similarly, when saddle stitch printing is set, the print data decision section 108 decides print data on which no saddle stitch layout process has been performed and to which a command for instructing the printer to perform a saddle stitch layout process inside the printer is added.

In this embodiment, when all printers capable of performing printing have the N-Up function and the saddle stitch function, print data on which a layout process for N-Up and saddle stitch has not been performed, i.e., dedicated print data meant for the printer having the N-Up function and the saddle stitch function, is used, thus making it possible to achieve the following effects. Since a layout process is performed by the printer, transmission/reception speed and processing speed for dedicated print data are higher than transmission/reception speed and processing speed for shared print data on which a layout process has been performed by the PC. Further, in the case of saddle stitch printing, a layout process is performed by the printer, thereby allowing the layout to be changed in accordance with the number of pages that can be stapled. For example, the number of combined pages for N-Up can be automatically changed in accordance with an upper limit for the number of pages that can be stapled; thus, when the upper limit for the number of pages is exceeded in the case of 2-Up, for example, N-Up setting can be automatically changed to 4-Up by the printer.

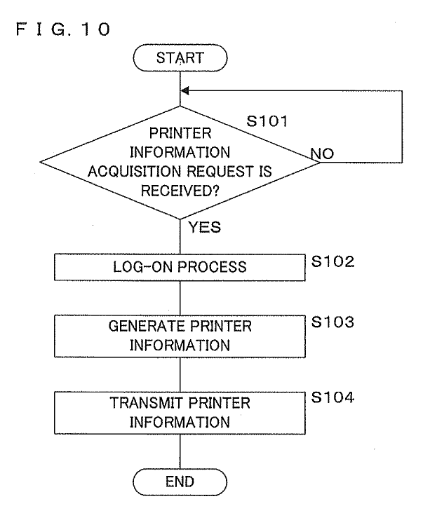

FIG. 10 is a flow chart illustrating a procedure of processing for transmitting printer information with the server 20. As illustrated in FIG. 10, the CPU 201 in the server 20 determines whether or not a printer information acquisition request is received from the PC 10 (Step S101). Upon determination that no printer information acquisition request is received from the PC 10 (Step S101: NO), the determination in Step S101 is repeatedly made until a printer information acquisition request is received.

Upon determination that a printer information acquisition request is received from the PC 10 (Step S101: YES), the CPU 201 carries out a log-on process based on log-on information received along with the acquisition request, thus identifying the user who has transmitted the acquisition request (Step S102).

Based on the printer setting information table accumulated in the information accumulation section 208, the CPU 201 determines the printers usable by the identified user, generates printer information associated with the user and illustrated in FIG. 9A, for example (Step S103), and instructs the printer information transmission section 209 to transmit the printer information.

In accordance with the instruction from the CPU 201, the printer information transmission section 209 transmits the generated printer information to the PC via the PC I/F 210 (Step S104). Then, the CPU 201 ends the processing.

Thus, in accordance with the user's request provided from the PC 10, the server 20 can transmit, to the PC 10, the printer information associated with the user.

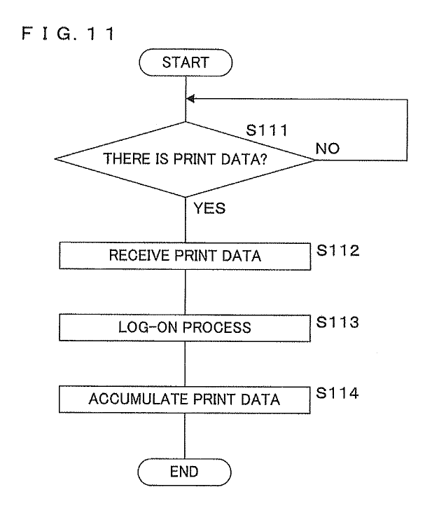

FIG. 11 is a flow chart illustrating a procedure of processing for accumulating print data in the server 20. As illustrated in FIG. 11, the CPU 201 determines whether or not there is print data to be received in the PC 10 (Step S111). Upon determination that there is no print data to be received in the PC 10 (Step S111: NO), the determination in Step S111 is repeatedly made until there is print data to be received in the PC 10.

Upon determination that there is print data to be received in the PC 10 (Step S111: YES), the CPU 201 instructs the print data reception section 204 to receive the print data.

In accordance with the instruction from the CPU 201, the print data reception section 204 receives the print data from the PC 10 via the PC I/F 210 (Step S112).

Based on log-on information received along with the print data, the CPU 201 identifies the user who has transmitted the print data (Step S113), accumulates the received print data in the print data accumulation section 205 so that the received print data is associated with the user (Step S114), and then ends the processing.

Thus, the server 20 can receive the print data from the PC 10, accumulate the received print data in the print data accumulation section 205, and transmit the print data in response to an acquisition request from the printer.

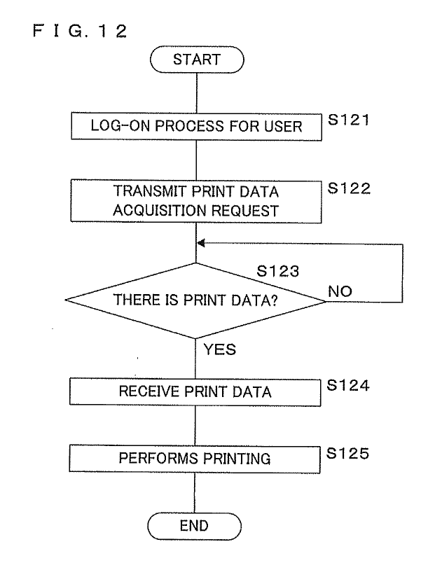

FIG. 12 is a flow chart illustrating a procedure of processing for acquiring print data and performing printing with a printer. The processing performed by a printer will be described using an example in which printing is performed by the second printer 32.

For the second printer 32, the user inputs log-on information such as a log-on name and a password, for example, via the user I/F 318, and then the CPU 311 instructs the log-on processing section 315 to perform a log-on process for the user. In accordance with the instruction from the CPU 311, the log-on processing section 315 performs the log-on process for the user (Step S121).

The CPU 311 transmits a print data acquisition request to the server 20 (Step S122), and at the same time, the CPU 311 also transmits the user's log-on information to the server 20.

The CPU 311 determines whether or not there is print data to be received in the server 20 (Step S123). Upon determination that there is no print data to be received in the server 20 (Step S123: NO), the process of Step S123 is repeatedly performed until there is print data to be received in the server 20.

Upon determination that there is print data to be received in the server 20 (Step S123: YES), the CPU 311 instructs the print data reception section 316 to receive the print data. In accordance with the instruction from the CPU 311, the print data reception section 316 receives the print data (Step S124).

The CPU 311 instructs the printing section 317 to perform printing. In accordance with the instruction from the CPU 311, the printing section 317 performs printing based on the received print data (Step S125). Then, the CPU 311 ends the processing.

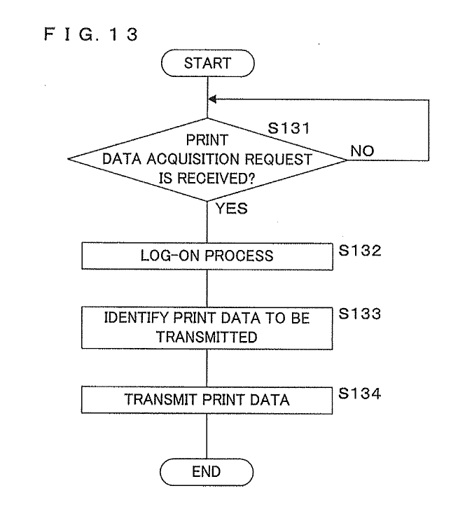

FIG. 13 is a flow chart illustrating a procedure of processing for transmitting print data with the server 20. In the present embodiment, the processing for transmitting print data to the printer is carried out through the print data transmission section 206, for example.

As illustrated in FIG. 13, the print data transmission section 206 determines whether or not a print data acquisition request from the printer is received (Step S131). Upon determination that no print data acquisition request from the printer is received (Step S131: NO), the process of Step S131 is repeatedly performed until a print data acquisition request is received.

Upon determination that a print data acquisition request from the printer is received (Step S131: YES), the print data transmission section 206 carries out a log-on process based on the user's log-on information received along with the acquisition request, and identifies the user, who has made the acquisition request, based on the user registration information accumulated in the information accumulation section 208 (Step S132).

The print data transmission section 206 identifies, from the print data accumulated in the print data accumulation section 205, the print data associated with the identified user (Step S133), transmits the identified print data for printing (Step S134), and then ends the processing.

In the printing system 1 according to the present embodiment,

information of: users who utilize the printing system 1; and printers usable by the users is registered in the server 20 in advance. When print data is generated in the PC 10, a printer information acquisition request and user's log-on information are transmitted to the server 20. Upon reception of the printer information acquisition request from the PC 10, the server 20 performs a log-on process for the user based on the user's log-on information received along with the acquisition request, identifies the user and determines the printers usable by the user based on the information of the users and printers registered in advance, and generates printer information to transmit the generated printer information to the PC 10. Upon reception of the printer information from the server 20, the PC 10 acquires, from the retained type information of is each printer, information concerning printing functions of the usable printers. When the respective printers have the same type of printing functions which are all identical, the PC 10 generates dedicated print data printable by the identical printing function; on the other hand, when the respective printers have the same type of printing functions which are not identical, the PC 10 creates shared print data printable by these printing functions. Then, the PC 10 transmits the generated print data and the user's log-on information to the server 20. Based on the user's log-on information received along with the print data, the server 20 performs a log-on process to identify the user, and accumulates the print data, which has been received from the PC 10, so that the print data is associated with the user.

Thus, the print data can be generated based on the printing functions of the usable printers, thereby making it possible to generate the print data most suitable for the printer to be actually used, and to increase speed of data transmission/reception and printing process.

When a printing process is performed, the printer performs a log-on process for the user, and transmits a print data acquisition request and user's log-on information to the server 20. Based on the user's log-on information from the printer, the server 20 identifies the user, identifies the print data accumulated so as to be associated with the user, and transmits the identified print data to the printer. The printer receives the print data from the server 20, and performs printing based on the print data.

Thus, the print data generated by the PC 10 is accumulated in the server 20, and the printer for performing printing acquires the print data from the server 20 to perform printing. Hence, a printer incapable of performing printing due to occurrence of trouble, e.g., a printer that is out of paper or toner or a printer in which a paper jam has occurred, can be avoided in carrying out printing, and the print data is managed by the server 20, thereby making it possible to manage, for example, the number of pages to be printed for each user.

### Embodiment 2

In Embodiment 2, the print data decision section 108 according to Embodiment 1 is provided in the server. Note that in the following description, reference should be made to Embodiment 1 for constituent elements similar to those of Embodiment 1, and the description thereof will be omitted. It should also be noted that the constituent elements similar to those of Embodiment 1 are identified by the same reference characters as those used in Embodiment 1.

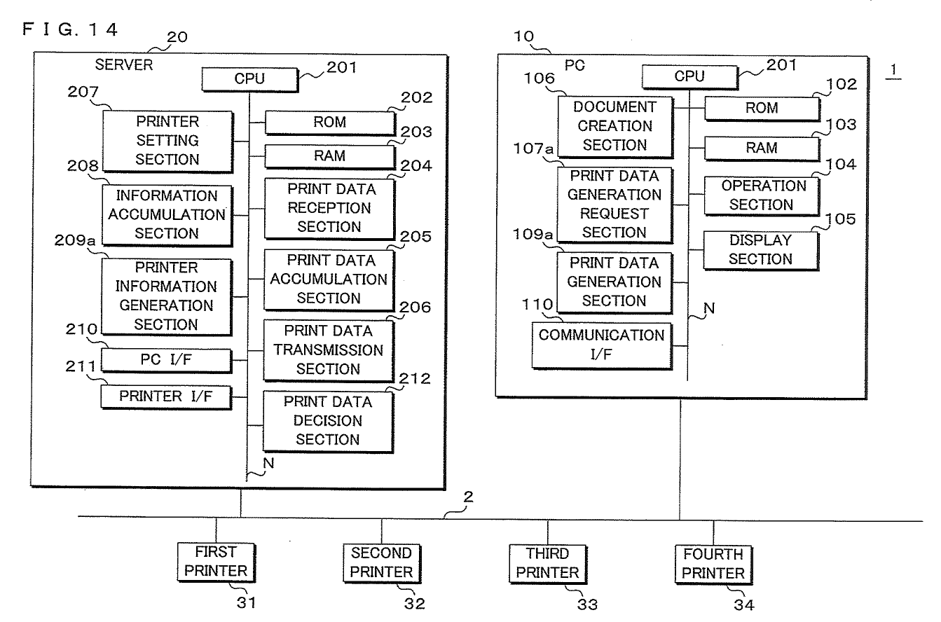

FIG. 14 is a block diagram illustrating configurations of main devices of a printing system 1 according to Embodiment 2 of the present invention. As illustrated in FIG. 14, Embodiment 2 differs from Embodiment 1 in that a print data generation request section 107a and a print data generation section 109a are provided in the PC 10, and a printer information generation section 209a and a print data decision section 212 are provided in the server 20.

In the PC 10, the print data generation request section 107a is a printer driver, for example. The print data generation request section 107a transmits a print data generation request to the server 20; at the same time, the print data generation request section 107a also transmits, to the server 20, print setting made by the user and log-on information such as the user's log-on name and password.

In the server 20, the printer information generation section 209a determines, in response to the print data generation request from the print data generation request section 107a of the PC 10, the printers usable by the user based on the received user's log-on information and printer setting information accumulated in the information accumulation section 208, and generates printer information associated with the user.

The print data decision section 212 retains model information (see FIG. 9B) of the first to fourth printers 31 to 34 in advance. Based on the retained model information of each printer and the printer information generated by the printer information generation section 209a, the print data decision section 212 obtains information concerning printing functions of the printers usable by the user so as to decide, based on the information, whether to generate shared print data printable by a plurality of printing functions or to generate dedicated print data printable by a single printing function.

The print data generation section 109a in the PC 10 is a printer driver, for example. The print data generation section 109a receives, from the server 20, a result of the decision made by the print data decision section 212, and generates shared print data or dedicated print data in accordance with the result of the decision. The CPU 101 transmits the print data, generated by the print data generation section 109a, to the server 20 via the communication I/F 110.

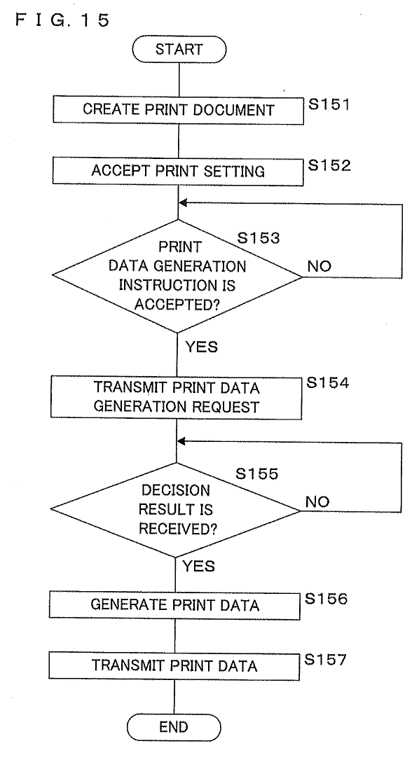

FIG. 15 is a flow chart illustrating a procedure of processing performed by the PC 10 according to Embodiment 2. As illustrated in FIG. 15, the document creation section 106 in the PC 10 creates, in accordance with an instruction from the CPU 101, a document to be printed (Step S151).

The CPU 101 accepts a print setting operation performed by the user (Step S152). The CPU 101 determines whether or not a print data generation instruction is accepted from the user (Step S153). Upon determination that no print data generation instruction is accepted from the user (Step S153: NO), the determination in Step S153 is repeatedly made until a print data generation instruction is accepted.

Upon determination that a print data generation instruction is accepted from the user (Step S153: YES), the CPU 101 instructs the print data generation request section 107a to transmit a print data generation request. In accordance with the instruction from the CPU 101, the print data generation request section 107a transmits the print data generation request to the server 20 via the communication I/F 110; at the same time, the print data generation request section 107a also transmits printer setting made by the user and log-on information such as the user's log-on name and password to the server 20 via the communication I/F 110 (Step S154).

The CPU 101 determines whether or not a print data decision result is received from the server 20 (Step S155). Upon determination that no print data decision result is received from the server 20 (Step S155: NO), the determination in Step S155 is repeatedly made until a print data decision result is received.

Upon determination that a print data decision result is received from the server 20 (Step S155: YES), the CPU 101 instructs the print data generation section 109a to generate print data. In accordance with the instruction from the CPU 101, the print data generation section 109a generates print data based on the received decision result (Step S156).

The CPU 101 transmits the generated print data and user information such as the user's log-on name and password to the server 20 via the communication I/F 110 (Step S157), and then ends the processing.

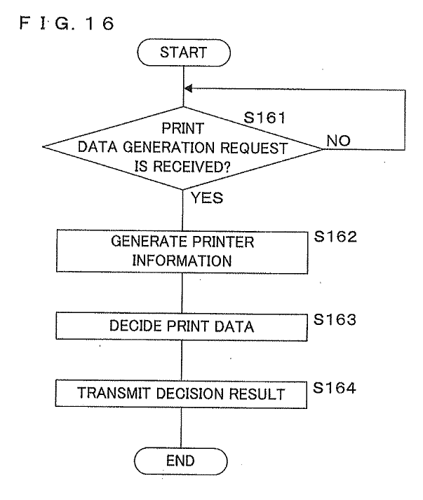

FIG. 16 is a flow chart illustrating a procedure of processing performed by the server 20 according to Embodiment 2. As illustrated in FIG. 16, the CPU 201 in the server 20 determines whether or not a print data generation request is received from the PC 10 (Step S161). Upon determination that no print data generation request is received from the PC 10 (Step S161: NO), the determination in Step S161 is repeatedly made until a print data generation request is received.

Upon determination that a print data generation request is received from the PC 10 (Step S161: YES), the CPU 201 determines the printers, usable by the user, based on the received log-on information and the printer setting information table accumulated in the information accumulation section 208, and generates, the printer information associated with the user and illustrated in FIG. 9A for example (Step S162).

The CPU 201 instructs the print data decision section 212 to decide print data. In accordance with the instruction from the CPU 201, the print data decision section 212 invokes the subroutine (see FIG. 7) for deciding print data, and decides what kind of print data should be generated (Step S163).

The CPU 201 transmits a result of the decision made in Step S163 to the PC 10 via the PC I/F 210 (Step S164), and then ends the processing.

For example, when the user “E” does not set N-Up and saddle stitch in trying to perform printing, the server 20 notifies the PC of “black-and-white only” provided as an item of “color/black-and-white” in the print data decision table such as one illustrated in FIG. 9D. When the user “E” sets N-Up in trying to perform printing, the server 20 notifies the PC of “black-and-white only” provided as an item of “color/black-and-white” and “shared” provided as an item of “N-Up” in the print data decision table such as one illustrated in FIG. 9D. Thus, the amount of information in the print data decision table for the PC 10 can be limited, and the information processing burden on the PC 10 can be reduced.

In the present embodiment, the print data decision section 212 is provided in the server, thereby allowing the PC to avoid a burdensome process for selecting a suitable type of print data from a large number of combinations of printer functions and a large number of combinations of settings made at the time of printing.

### Embodiment 3

A printing system 1 according to Embodiment 3 of the present invention is configured so that each computer program for performing an operation can be provided via a portable recording medium such as a CD-ROM. Moreover, the printing system 1 may be configured so that such a computer program can also be downloaded from an external device.

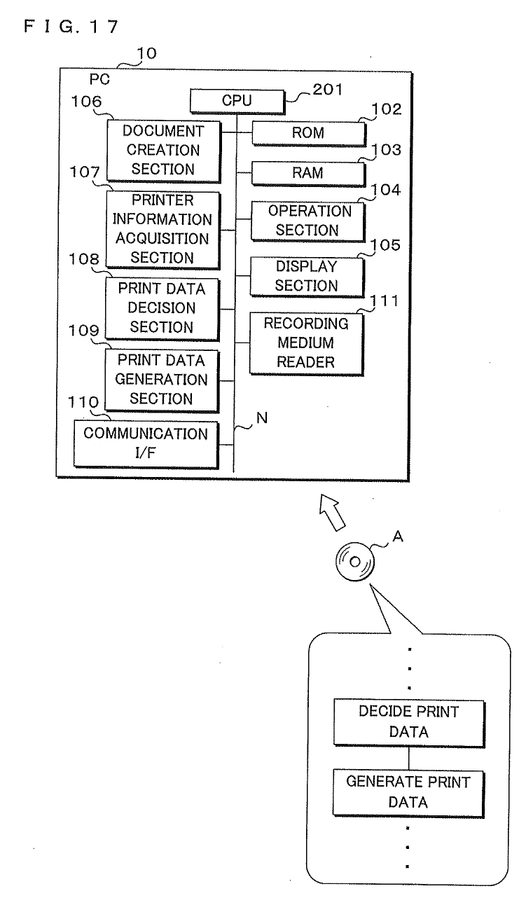

In the following description, a program for performing an operation in a PC is used as an example, but the present invention is not limited to such an example. For example, the present invention may also be applied to the server 20. FIG. 17 is a block diagram illustrating an exemplary configuration of a PC according to Embodiment 3. As illustrated in FIG. 17, the PC 10 further includes a recording medium reader 111. When print data is generated, the PC 10 decides to generate shared print data or dedicated print data based on information concerning printing functions of printers, a portable recording medium A in which a program or the like for generating shared print data or dedicated print data is recorded is inserted into the recording medium reader 111, and the program is installed on the ROM 102 by the CPU 101, for example. The program is loaded onto the RAM 103 and executed. Thus, the PC 10 functions as a print data generator according to the present invention.

The recording medium may be a so-called program medium. Specifically, the recording medium may be a medium carrying a program code in a fixed manner, and examples of the recording medium may include: tapes such as a magnetic tape and a cassette tape; disks including magnetic disks such as a flexible disk and a hard disk, and optical disks such as a CD-ROM, an MO, an MD and a DVD; cards such as an IC card (including a memory card) and an optical card; and semiconductor memories such as a mask ROM, an EPROM, an EEPROM and a flash ROM.

Alternatively, the recording medium may be a medium carrying a program code in a state of flux so that a program code is downloaded by network. Note that when a program is downloaded by communication network in this manner, the program to be downloaded may be stored in a main apparatus in advance or may be installed from another recording medium. It should also be noted that the present invention can also be realized in a form of a computer data signal embedded in a carrier wave, in which the program code is embodied by electronic transmission.

The server 20 for managing printing is used in the printing system 1 according to each of the foregoing embodiments, but the present invention is not limited to this configuration. Alternatively, the printing system 1 may be configured so that the PC 10 is allowed to function as a server. Further, the first to fourth printers 31 to 34 are only required to include printing functions and communication functions, and may further include other functions such as copy functions, facsimile functions and scanner functions.

Furthermore, in each of the foregoing embodiments, log-on information including a log-on name and a password is used to identify a user, but the present invention is not limited to this. Alternatively, other identifying means may be used. For example, an ID card or the like may be used to identify a user.

Moreover, each of the foregoing embodiments has been described about a case where a single printer is selected from a plurality of printers to perform printing, but the present invention is not limited to this. Alternatively, when necessary, a print job may be divided into a plurality of print jobs and a plurality of printers may be selected to perform printing.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A printing system comprising:
a plurality of printers;
a print data generation section for generating print data printable by one or a plurality of the printers; and
a decision section for deciding, based on information concerning printing functions of each of the plurality of printers, whether to generate shared print data printable by a plurality of printing functions or to generate dedicated print data printable by a single printing function,
wherein the print data generation section generates the shared print data or the dedicated print data based on a result of the decision made by the decision section.

2. The printing system according to claim 1,
wherein when all pieces of information concerning the same type of printing functions of the plurality of printers are identical, the decision section decides to generate the dedicated print data, and when the pieces of information concerning the same type of printing functions of the plurality of printers are not identical, the decision section decides to generate the shared print data.

3. The printing system according to claim 2, further comprising:
a setting section for registering a plurality of users and the plurality of printers, and for making a setting to allow each of the printers to be usable or unusable for each user; and
a determination section for acquiring user information, and for determining, based on the setting made by the setting section, the printers, of the plurality of printers, usable by the user associated with the acquired information,
wherein the decision section decides whether to generate the shared print data or to generate the dedicated print data based on the information concerning the printing functions of the printer determined by the determination section.

4. The printing system according to claim 1, further comprising:
a setting section for registering a plurality of users and the plurality of printers, and for making a setting to allow each of the printers to be usable or unusable for each user; and
a determination section for acquiring user information, and for determining, based on the setting made by the setting section, the printers, of the plurality of printers, usable by the user associated with the acquired information,
wherein the decision section decides whether to generate the shared print data or to generate the dedicated print data based on the information concerning the printing functions of the printer determined by the determination section.

5. A print data generator for generating print data, the print data generator comprising:
an acquisition section for acquiring information concerning a plurality of printing functions; and
a decision section for deciding, based on the information acquired by the acquisition section, whether to generate shared print data printable by a plurality of printing functions or to generate dedicated print data printable by a single printing function,
wherein the print data generator generates the shared print data or the dedicated print data based on a result of the decision made by the decision section.

6. A processor for carrying out a process for deciding print data printable by one or a plurality of printers to be connected, the processor comprising a decision section for deciding, based on information concerning printing functions of the plurality of printers, whether to generate shared print data printable by a plurality of printing functions or to generate dedicated print data printable by a single printing function.

7. A printing method for generating print data printable by one or a plurality of printers, and for performing printing based on the generated print data, the method comprising the steps of:
deciding, based on information concerning printing functions of each of the plurality of printers, whether to generate shared print data printable by a plurality of printing functions or to generate dedicated print data printable by a single printing function; and
generating the shared print data or the dedicated print data based on a result of the decision.

8. A non-transitory recording medium in which a computer program for a computer for generating print data printable by one or a plurality of printers to be connected is recorded, the computer program comprising the steps of;
allowing the computer to decide, based on information concerning printing functions of the plurality of printers, whether to generate shared print data printable by a plurality of printing functions or to generate dedicated print data printable by a single printing function; and
allowing the computer to generate the shared print data or the dedicated print data based on a result of the decision.
